(19) United States
(12) Patent Application Publication
(10) Pub. No.: US 2007/0080928 A1
(43) Pub. Date: Apr. 12, 2007

(54) Display control apparatus, display device, and control method for a display device

(75) Inventors: Junichiro Ishii, Matsumoto-shi (JP); Shintaro Nagasaki, Azumino-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/545,693

(22) Filed: Oct. 11, 2006

(30) Foreign Application Priority Data
Oct. 12, 2005 (JP) JP 2005-298187

(51) Int. Cl. G09G 3/34

(52) U.S. Cl. 345/107

(57) ABSTRACT

A display control apparatus for controlling an electrophoretic display panel 5 having two types of electrophoretic particles of different color and polarity between electrodes has a display drive circuit 40 for supplying a pulse wave drive signal to apply a drive voltage between the electrodes to change the display color of the electrophoretic display panel to a color between the colors of the electrophoretic particles and display a gray level color, and a control unit 57 for controlling migration of the electrophoretic particles by means of the display drive circuit 40 based on the target display color, which is the display color to which the display is to be changed, and the difference in the migration characteristics of the two types of electrophoretic particles. By considering the migration characteristics of the electrophoretic particles of each color when changing the display color of the electrophoretic display panel, the discordance that can result when changing the display color is reduced.

### BACKGROUND

1. Technical Field

The present invention relates to a display control apparatus for controlling an electrophoretic display panel, to a display device having an electrophoretic display panel, and to a control method for such a display device.

2. Related Art

Display devices having an electrophoretic display panel that uses electrophoresis, a phenomenon whereby charged particles dispersed in a fluid migrate when an electric field is applied, are known from the literature. An electrophoretic display panel such as taught in Japanese Unexamined Patent Appl. Pub. S52-70791 has a sealed electrophoretic layer containing white and black electrophoretic particles disposed between electrodes so that when a positive or negative drive voltage is applied between the electrodes, either the white or black electrophoretic particles migrate to the display surface side so that the color displayed at the display surface is white or black.

However, when the display color of an electrophoretic display panel is switched by applying the same voltage, the time required to switch the display from white to black differs from the time required to switch the display from black to white.

The time required to switch the display color is not limited to switching from white to black or black to white, and the time also differs when displaying intermediate gray scale colors. The time required to switch from a white display (100% relative density) to a 50% (relative density) gray level differs from the time required to switch from a black display (0% relative density) to a 50% (relative density) gray level, for example.

As a result, when adjacent display areas (or adjacent segments) are simultaneously switched to the same display color, the time required to complete the change depends upon the original display color, and the effect may be visually discordant.

### SUMMARY OF THE INVENTION

An object of the present invention is therefore to provide a display control apparatus, a display device, and a display device control method that can ameliorate the odd effect of changing the display color.

To achieve this object, a display control apparatus according to a first aspect of the invention controls an electrophoretic display panel having two types of electrophoretic particles of different color and polarity between electrodes, and the display control apparatus has a drive unit for supplying a pulse wave drive signal to apply a drive voltage between the electrodes to change a display color of the electrophoretic display panel to a color between the colors of the electrophoretic particles and display a gray level color; and a migration state control unit for controlling migration of the electrophoretic particles by means of the drive unit based on the target display color, which is the display color to be displayed, and the difference in the migration characteristics of the two types of electrophoretic particles.

The drive unit thus supplies a pulse wave drive signal to apply a drive voltage between the electrodes to change a display color of the electrophoretic display panel to a color between the colors of the electrophoretic particles and display a gray level color as controlled by the migration state control unit.

The migration state control unit thus controls migration of the electrophoretic particles by means of the drive unit based on the target display color, which is the display color to be displayed, and the difference in the migration characteristics of the two types of electrophoretic particles.

As a result, the discordance resulting from the display color changing at different times when the display color of an electrophoretic display panel is changed can therefore be prevented because the migration characteristics of the different color electrophoretic particles are considered when changing the display color.

Preferably, the migration state control unit has a migration timing control unit for controlling a migration start time by means of the drive unit so that the migration end time is the same in all areas when changing a plurality of areas of different display colors to the same color.

By thus adjusting the timing when electrophoretic particle migration starts so that the migration end time is the same in all display areas, the display color can be completely redrawn at substantially the same time across the entire display, and the discordance caused by the display color changing at different times can be reduced.

In another aspect of the invention, the migration state control unit has a pulse application control unit for controlling a pulse application time by means of the drive unit so that the migration end time is the same in all areas when changing a plurality of areas of different display colors to the same color.

By thus adjusting the timing when drive pulses are applied so that the migration end time is the same in all display areas, the display color can be completely redrawn at substantially the same time across the entire display, and the discordance caused by the display color changing at different times can be reduced.

In another aspect of the invention, the migration state control unit has a voltage control unit for changing the voltage of the drive signal applied to each area so that the migration end time is the same in all areas when changing a plurality of areas of different display colors to the same color.

By thus adjusting the voltage of the drive signal applied to each display area so that the migration end time is the same in all display areas, the display color can be completely redrawn at substantially the same time across the entire display, and the discordance caused by the display color changing at different times can be reduced.

In yet another aspect of the invention the migration state control unit has a pulse width control unit for controlling the drive signal pulse width by means of the drive unit so that the migration end time is the same in all areas when changing a plurality of areas of different display colors to the same color.

By thus adjusting the pulse width of the drive signal applied to each display area so that the migration end time is the same in all display areas, the display color can be completely redrawn at substantially the same time across the entire display, and the discordance caused by the display color changing at different times can be reduced.

Yet further preferably, the display control apparatus also has a pulse data storage table for storing a pulse count of a pulse wave drive signal or the voltage application time effected by a pulse wave drive signal required to change from a current display color to a target display color, and the migration state control unit references the pulse data storage table to control the migration state of the electrophoretic particles when changing the display color of display areas of a plurality of different display colors to the same color.

The migration state control unit thus references the pulse data storage table to control the migration state of the electrophoretic particles when changing the display color of display areas of a plurality of different display colors to the same color, and can thus reduce the sense of discordance resulting from the display color changing at different times because the migration characteristics of the different color electrophoretic particles are considered when changing the display color even though the arrangement is simple.

A display device according to another aspect of the invention has an electrophoretic display panel having two types of electrophoretic particles of different color and polarity between electrodes; a drive unit for supplying a pulse wave drive signal to apply a drive voltage between the electrodes to change a display color of the electrophoretic display panel to a color between the colors of the electrophoretic particles and display a gray level color; and a migration state control unit for controlling migration of the electrophoretic particles by means of the drive unit based on the target display color, which is the display color to be displayed, and the difference in the migration characteristics of the two types of electrophoretic particles.

Preferably, the migration state control unit has a migration timing control unit for controlling a migration start time by means of the drive unit so that the migration end time is the same in all areas when changing a plurality of areas of different display colors to the same color.

As a result, the discordance resulting from the display color changing at different times when the display color of an electrophoretic display panel is changed can therefore be prevented because the migration characteristics of the different color electrophoretic particles are considered when changing the display color.

Preferably, the migration state control unit has a pulse application control unit for controlling a pulse application time by means of the drive unit so that the migration end time is the same in all areas when changing a plurality of areas of different display colors to the same color.

By thus adjusting the timing when drive pulses are applied so that the migration end time is the same in all display areas, the display color can be completely redrawn at substantially the same time across the entire display, and the discordance caused by the display color changing at different times can be reduced.

In another aspect of the invention, the migration state control unit has a voltage control unit for changing the voltage of the drive signal applied to each area so that the migration end time is the same in all areas when changing a plurality of areas of different display colors to the same color.

By thus adjusting the voltage of the drive signal applied to each display area so that the migration end time is the same in all display areas, the display color can be completely redrawn at substantially the same time across the entire display, and the discordance caused by the display color changing at different times can be reduced.

In yet another aspect of the invention the migration state control unit has a pulse width control unit for controlling the drive signal pulse width by means of the drive unit so that the migration end time is the same in all areas when changing a plurality of areas of different display colors to the same color.

By thus adjusting the pulse width of the drive signal applied to each display area so that the migration end time is the same in all display areas, the display color can be completely redrawn at substantially the same time across the entire display, and the discordance caused by the display color changing at different times can be reduced.

Yet further preferably, the display device also has a pulse data storage table for storing a pulse count of a pulse wave drive signal or the voltage application time effected by a pulse wave drive signal required to change from a current display color to a target display color, and the migration state control unit references the pulse data storage table to control the migration state of the electrophoretic particles when changing the display color of display areas of a plurality of different display colors to the same color.

The migration state control unit thus references the pulse data storage table to control the migration state of the electrophoretic particles when changing the display color of display areas of a plurality of different display colors to the same color, and can thus reduce the sense of discordance resulting from the display color changing at different times because the migration characteristics of the different color electrophoretic particles are considered when changing the display color even though the arrangement is simple.

Another aspect of the invention is a display control method for a display device having an electrophoretic display panel having two types of electrophoretic particles of different color and polarity between electrodes and a display unit for driving the electrophoretic display panel, the display control method having steps of: supplying a pulse wave drive signal to apply a drive voltage between the electrodes to change a display color of the electrophoretic display panel to a color between the colors of the electrophoretic particles and display a gray level color; and controlling migration of the electrophoretic particles by means of the drive unit based on the target display color, which is the display color to be displayed, and the difference in the migration characteristics of the two types of electrophoretic particles.

As a result, the discordance resulting from the display color changing at different times when the display color of an electrophoretic display panel is changed can therefore be prevented because the migration characteristics of the different color electrophoretic particles are considered when changing the display color.

Another aspect of the invention is a display control method for a display device having an electrophoretic display panel having two types of electrophoretic particles of different color and polarity between electrodes, a display unit for driving the electrophoretic display panel, and a pulse data storage table for storing a pulse count of a pulse wave drive signal or the voltage application time effected by a pulse wave drive signal required to change from a current display color to a target display color, the display control method having steps of: supplying a pulse wave drive signal to apply a drive voltage between the electrodes to change a display color of the electrophoretic display panel to a color between the colors of the electrophoretic particles and display a gray level color; and referencing the pulse data storage table to control migration of the electrophoretic particles by means of the drive unit based on the target display color, which is the display color to be displayed, and the difference in the migration characteristics of the two types of electrophoretic particles.

The migration state control step thus references the pulse data storage table to control the migration state of the electrophoretic particles when changing the display color of display areas of a plurality of different display colors to the same color, and can thus reduce the sense of discordance resulting from the display color changing at different times because the migration characteristics of the different color electrophoretic particles are considered when changing the display color even though the arrangement is simple.

### BRIEF DESCRIPTION OF THE DRAWINGS

FIG. 1 is a plan view of a wristwatch according to a preferred embodiment of the invention.

FIG. 2 describes the display panel of this wristwatch.

FIG. 3 is a schematic section view of the time display unit in the wristwatch.

FIG. 4 is a section view showing the arrangement of the display panel.

FIG. 5 is a block diagram showing the electrical arrangement of the time display unit.

FIG. 6 describes the relationship between the number of applied signal pulses and the display level.

FIG. 7 describes the relationship between the time when applying the drive voltage starts and the change in the display level.

FIG. 8 is a table showing the number of pulses applied to change from an initial display level to a particular target display level.

FIG. 9 shows an example of the waveform of the display panel drive signal.

### DESCRIPTION OF THE PREFERRED EMBODIMENTS

A preferred embodiment of the present invention is described below with reference to the accompanying figures.

### First Embodiment

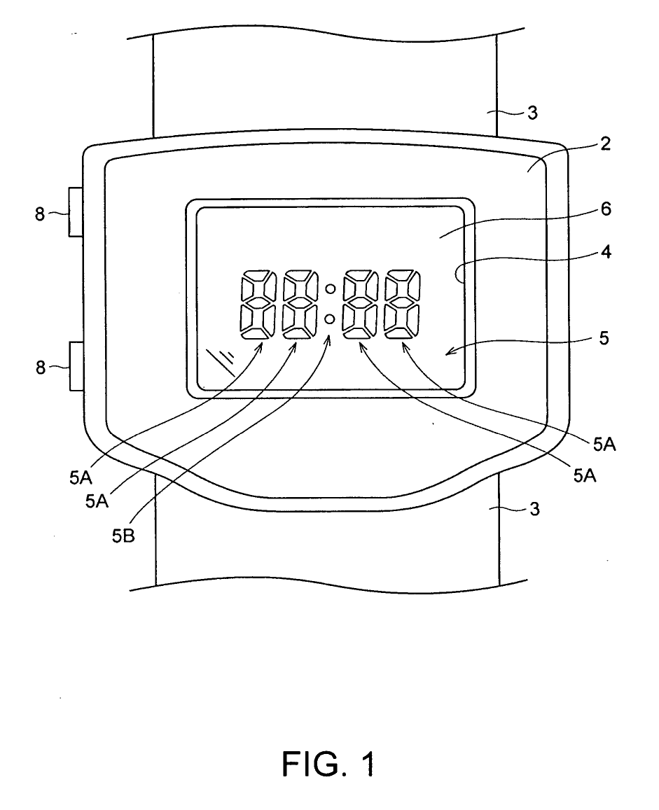

FIG. 1 shows the appearance of a wristwatch 1 according to this embodiment of the invention.

As shown in the figure, the wristwatch 1 has a watch case 2, and a wrist band 3 that is attached to the watch case 2 and used to hold the wristwatch 1 on the user's wrist.

A time display window 4 for displaying the time is formed in the front of the watch case 2 so that the display panel 5 that displays the time, for example, can be seen through the time display window 4. A crystal 6 made from transparent plastic or transparent glass, for example, is fit into the time display window 4, and the display panel 5 is protected by this crystal 6. Operating buttons 8 for setting the time, changing the operating mode, and performing other operations are also disposed to the watch case 2.

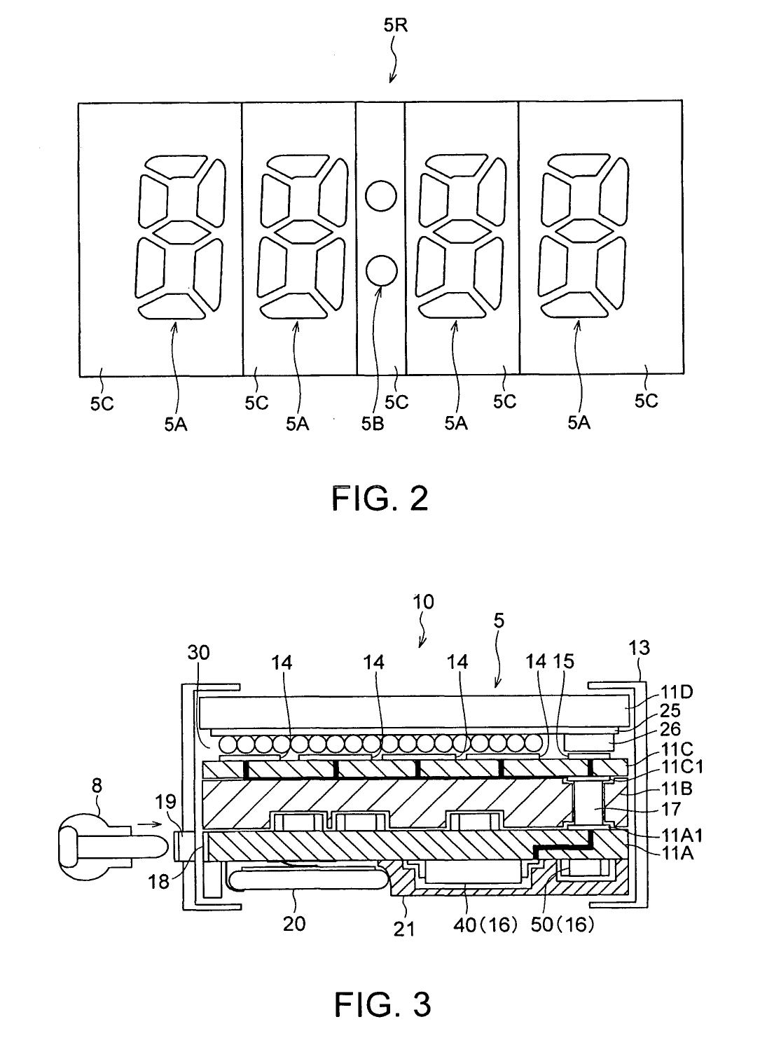

FIG. 2 describes the display panel of a wristwatch.

The display panel 5 is a segment display panel for displaying information using a plurality of segments. As shown in FIG. 2, the display area 5R of this display panel 5 has four segments (so-called “seven-segment displays”) 5A for displaying the numbers 0 to 9. The left two segments 5A display the hour of the time, and the right two segments 5A display the minute. A segment 5B comprising two circles for displaying a symbol (a colon in this example) separating the hour and minute is located between the hour segments 5A and the minute segments 5A.

As also shown in FIG. 2, a background segment 5C for displaying a background is also disposed to each of the segments 5A and 5B, and a background is displayed by these background segments 5C for each character (number or colon) displayed by the segments 5A and 5B. An electrophoretic display panel is used for the display panel 5 in this embodiment of the invention, and the construction of the display panel is further described in detail below. Segments 5A to 5C are referred to as segments 5X below when differentiating these segments 5A to 5C is not necessary.

A time display unit 10 rendered in unison with the display panel 5 is disposed inside the watch case 2.

FIG. 3 is a section view schematically showing the time display unit of the wristwatch.

As shown in the section view in FIG. 3, this time display unit 10 has a circuit board 11A, a display frame 11B, a display substrate 11C, a transparent substrate 11D, and a circuit retainer 13 for holding these other parts.

Segment electrodes 14 for each of the segments 5A to 5C, and a segment electrode 15 for a common electrode, are disposed on top of the display substrate 11C.

The circuit board 11A is on the bottom of the display substrate 11C with the display frame 11B therebetween. Electric circuit elements 16 including semiconductor devices rendering the display drive circuit 40 and control unit 50, for example, are mounted on the circuit board 11A. A node 11A1 wired to electric circuit element 16 (display drive circuit 40) is disposed on top of the circuit board 11A. A node 11C1 connected to the electrodes 14 and 15 is disposed on the bottom of the display substrate 11C, and these nodes 11A1 and 11C1 are electrically connected by a connector 17 passing through the display frame 11B.

A switch electrode 18 is disposed on the side of the circuit board 11A so that conductivity can be established by means of a flat spring 19 disposed to the circuit retainer 13. When the flat spring 19 is deformed as a result of depressing an operating button 8, conductivity is established through the flat spring 19. Whether the switch is open or closed is detected by a control unit 50 rendered by an electric circuit element 16.

A battery 20 (power supply) for supplying drive power to the electric circuit elements 16 is removably disposed on the bottom of the circuit board 11A. A circuit housing 21 covering the electric circuit elements 16 is affixed to the circuit board 11A, and the electric circuit elements 16 are thus protected by the circuit housing 21. A button battery, that is, a primary cell, is used for the battery 20 but the invention is not so limited and a secondary battery can be used instead.

A transparent common electrode 25 formed by ITO (indium tin oxide) vapor deposition, for example, is rendered on the display substrate 11C side of the transparent substrate 11D. An electrophoretic layer 30 is disposed between this transparent common electrode 25 and the segment electrodes 14 of the display substrate 11C. A common electrode conductor 26 is disposed between the transparent common electrode 25 and the common segment electrode 15. This common electrode conductor 26 is made of a conductive rubber, for example, so that the conductive rubber deforms according to the gap between the common electrode 25 and the common segment electrode 15 to assure a reliable connection between these electrodes 25 and 15.

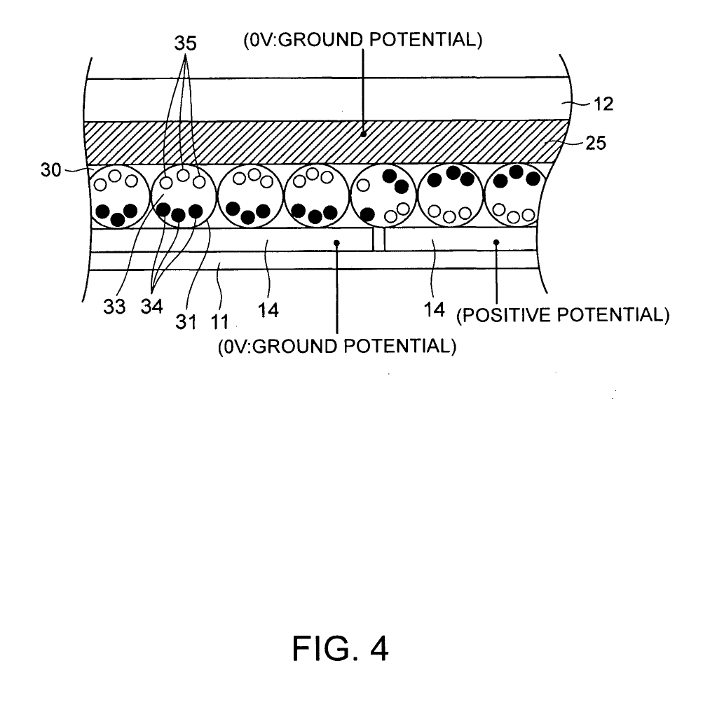

FIG. 4 is a section view describing the arrangement of the display panel.

As shown in FIG. 4, the electrophoretic layer 30 has a multitude of microcapsules 31, and the microcapsules 31 are filled with an electrophoretic dispersion 33. This electrophoretic dispersion 33 contains black electrophoretic particles (“black particles” below) 34 and white electrophoretic particles (“white particles” below) 35 in suspension, thus rendering a so-called two-particle electrophoretic layer. The black particles 34 and white particles 35 are oppositely charged, and in this embodiment of the invention the black particles 34 are positively charged while the white particles 35 are negatively charged.

When the display drive circuit 40 holds the common segment electrode 15 shown in FIG. 3 at 0 V (ground potential, referred to as LOW below) so that the common electrode 25 potential is 0 V, and a particular segment electrode 14 is driven to a positive potential (referred to as HIGH below), an electric field flowing from the segment electrode 14 to the common electrode 25 is created. This field causes the positively charged black particles 34 inside the microcapsules 31 to move to the common electrode 25 side, and causes the negatively charged white particles 35 to move to the segment electrode 14 side.

Conversely, when the display drive circuit 40 holds the common segment electrode 15 at a positive potential (HIGH) so that the common electrode 25 goes HIGH, and a particular segment electrode 14 goes LOW, the negatively charged white particles 35 inside the microcapsules 31 migrate to the common electrode 25 side and the positively charged black particles 34 move to the segment electrode 14 side.

Migration of the black particles 34 and white particles 35 to the transparent substrate 11D side (the common electrode 25 side) where the particles can be seen from the outside is thus adjusted by the display drive circuit 40 supplying drive signals to hold the common electrode 25 and segment electrodes 14 LOW or HIGH, and the display color of the segment 5X seen from the outside is thus switched between black and white (that is, black, white, and gray).

If a potential difference is not produced between the common electrode 25 and segment electrode 14, the electrophoretic particles (black particles 34, white particles 35) do not move, the display color of the segments 5X therefore does not change, and the previous display state is retained (the display has a memory function).

In this embodiment of the invention the display drive circuit 40 has an internal booster circuit to boost the voltage (such as 3 V) supplied from the battery 20 to produce a +12 V voltage, and supplies this +12 V voltage or 0 V as the drive voltage to the segment electrodes 14 and common electrode 25.

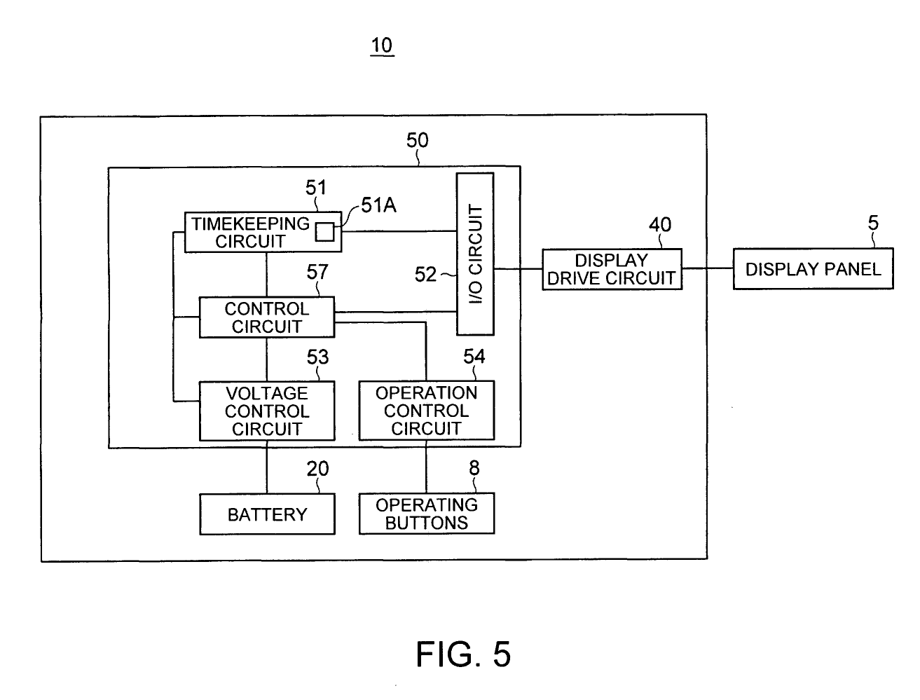

FIG. 5 shows the electrical arrangement of the time display unit 10.

A control unit 50 is electrically connected to the display drive circuit 40 and the battery 20 through an intervening wiring pattern rendered on the circuit board 11A. The control unit 50 has a timekeeping circuit 51, input/output (I/O) circuit 52, voltage control circuit 53, operation control circuit 54, and control circuit 57.

The timekeeping circuit 51 keeps the time by counting oscillation pulses from an oscillation circuit 51A. The timekeeping circuit 51 is connected to the display drive circuit 40 through the I/O circuit 52.

The voltage control circuit 53 supplies power from the battery 20 to the internal parts of the control unit 50 and the display drive circuit 40.

The operation control circuit 54 detects operation of the operating buttons 8 by detecting whether the switch electrode 18 is conductive or nonconductive, and reports the result to the control circuit 57.

The control circuit 57 centrally controls overall operation of the time display unit 10. The control circuit 57 is a microcomputer including a CPU, ROM, and RAM, for example. The CPU runs a control program stored in ROM to control operation of the parts of the control unit 50, and outputs signals to the display drive circuit 40 through the I/O circuit 52.

As described above, the display drive circuit 40 is a circuit for driving the display panel 5. The display drive circuit 40 is controlled by the control circuit 57 to get the time information kept by the timekeeping circuit 51. The display drive circuit 40 supplies drive signals applying a drive voltage between the electrodes at a specified redraw interval to change the display color of segments 5X in the display panel 5 and display the current time on the display panel 5 as the display information.

The display panel 5 drawing operation is described next.

The control circuit 57 in this embodiment of the invention manages the current display level (the “current level” below), which is equivalent to the current display color, of each segment 5X, sets the target display level (the “target level” below) for redrawing each segment 5X, and executes a drawing process that compares the current level and target level and drives the current level to the target level.

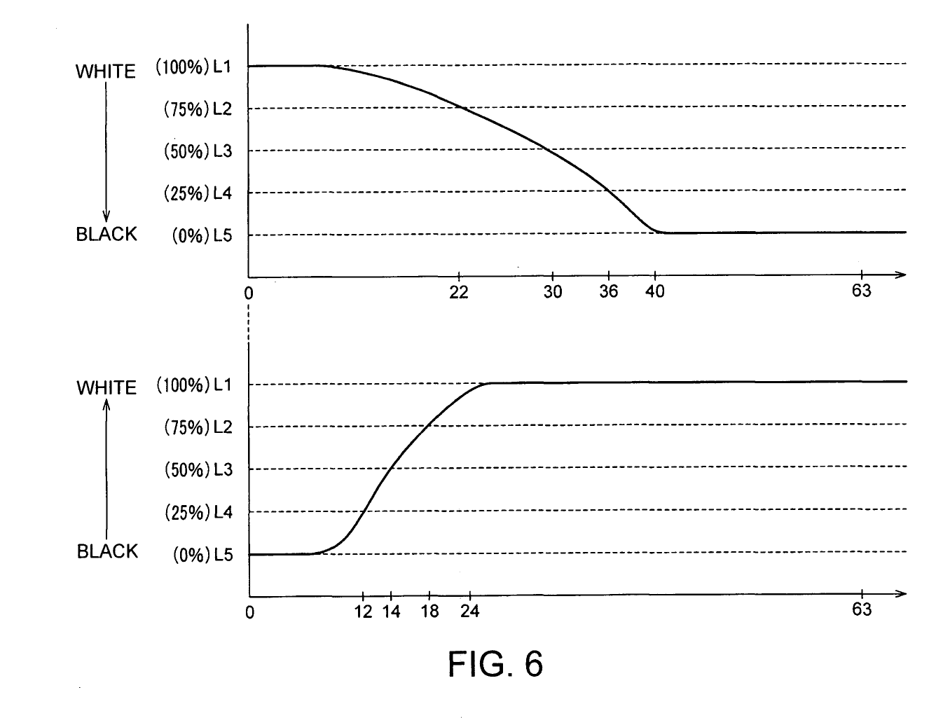

FIG. 6 shows the relationship between the number of applied pulses and the display level.

As shown in FIG. 6, in this aspect of the invention there are five display levels including three intermediate gray levels of 25%, 50%, and 75% relative reflectivity in addition to the two levels of 100% and 0% relative reflectivity where 100% relative reflectivity is white and 0% relative reflectivity is black.

This embodiment of the invention thus drives a five-level gray scale display. More specifically, a particular gray level is displayed by appropriately controlling the migration (distance moved) of the white particles 35 and black particles 34 in the microcapsules 31 according to the desired relative reflectivity of the display.

In the following description 100% relative reflectivity (white) is referred to as level L1, 75% relative reflectivity as level L2, 50% relative reflectivity as level L3, 25% relative reflectivity as level L4, and 0% relative reflectivity (black) as level L5.

Even if the difference in relative reflectivity is the same, changing from a high reflectivity level to a low level (FIG. 6, top) takes more time than changing from a low reflectivity level to a high level (FIG. 6, bottom).

More specifically, if from 0 to 63 pulses can be applied, the initial display level is level L1 (=white), and the display level is then changed to level L2, level L3, level L4, and level L5, the number of pulses required to change the display level is 22, 30, 36, and 40 pulses, respectively, as shown in FIG. 6.

However, if the initial display level is level L5 (=black), and the display level is then changed to level L4, level L3, level L2, and level L1, the number of pulses required to change the display level is 12, 14, 18, and 24 pulses, respectively.

If adjacent areas (segments) with an initial display level of level L1 and level L5 are simultaneously switched to the same gray level and the drive pulses are applied starting at the same time, the area (segment) where the initial display level was level L5 will reach the target display level first, the time required to switch to the same target display level is different in each area, and the difference in display levels can be visually dissonant the user.

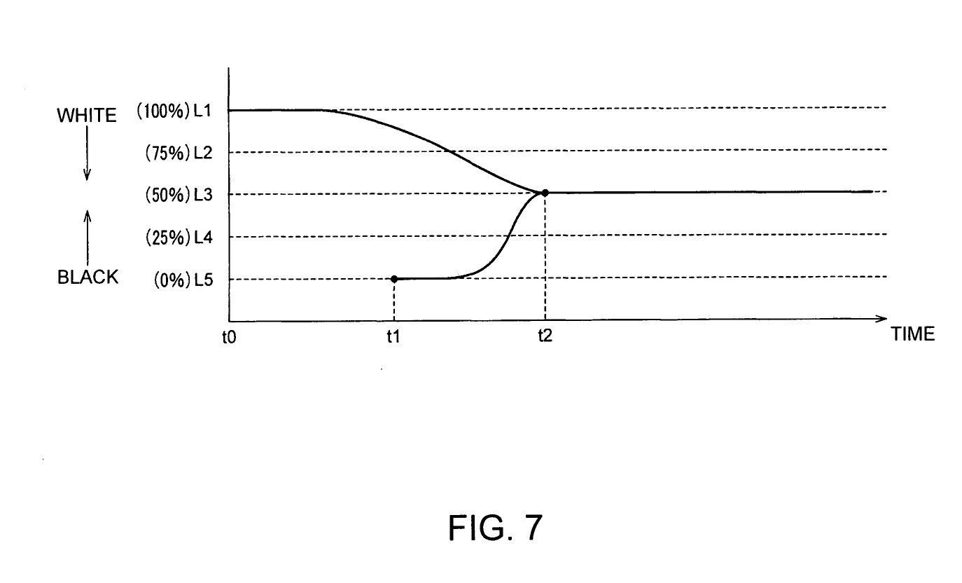

FIG. 7 describes the relationship between the time when drive pulses are first applied and the display level transition.

As shown in FIG. 7, when an area where the initial display level is level L1 (=white) and an area where the initial display level is level L5 (=black) are both switched to level L3, the area where the initial display level is level L1 (=white) takes longer to change color and drive pulses are therefore applied starting from time t0.

If drive pulses are applied starting at time t1 in the area where the initial display level is level L5 (=black), however, the area will be completely redrawn to level L3 at the same time t2, and there will therefore be no difference in display levels creating visual dissonance for the user.

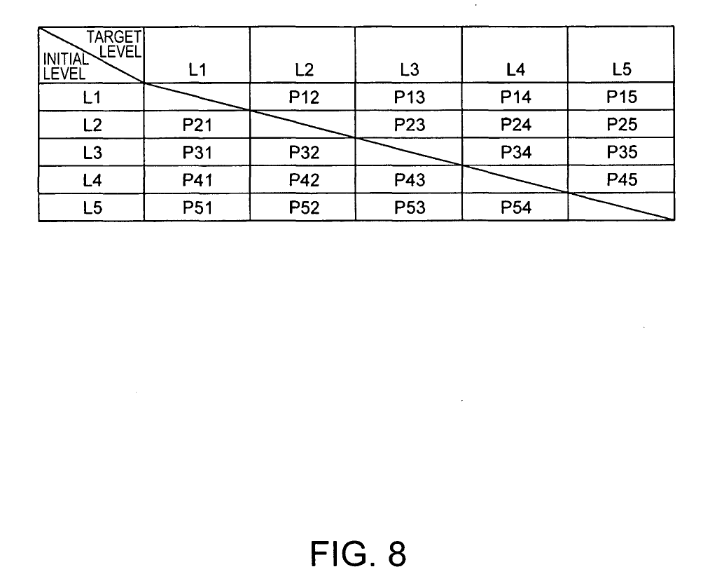

FIG. 8 is a table showing the number of drive pulses applied at a particular initial display level to achieve a particular target display level.

As described above, when changing the display from different initial display levels to the same level, the number of drive pulses required, and therefore the time, differ.

This aspect of the invention therefore stores the number of pulses required to change each initial display level to each target display level in a table as shown in FIG. 8, and pulses are applied to each display area starting at a time that is adjusted according to the number of pulses that must be applied.

For example, when an area where the initial display level is level L1 (=white) and an area where the initial display level is level L5 (=black) are both switched to level L3, the number of pulses required to redraw the area where the initial display level is level L1 (=white) is P13 and the number of pulses required to redraw the area where the initial display level is level L5 (=black) is P53 (<P13). The timing of the first pulse applied to the area that requires the smaller number of pulses (in this embodiment of the invention the area where the initial display level is level L5 (black)) is therefore delayed by the time equivalent to the pulse count difference ΔP,
ΔP=|P53−P13|
in order to completely redraw the display areas to the same display level at the same time.

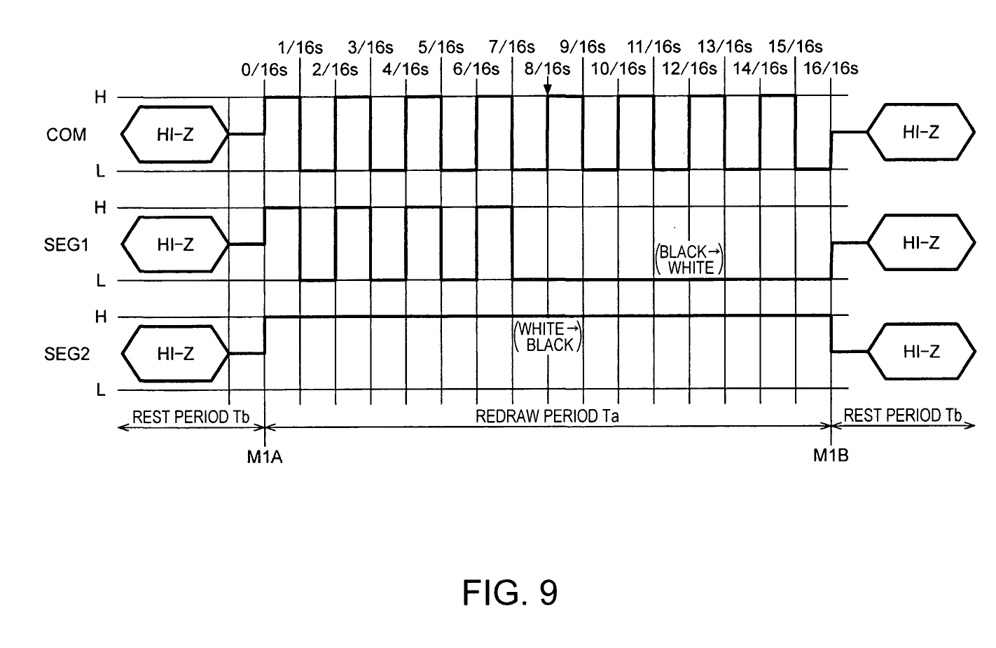

FIG. 9 shows an example of the waveform of the display panel drive signal.

In FIG. 9 COM is the drive signal (drive voltage) supplied to the common electrode 25, SEG1 is the drive signal (drive voltage) applied to the segment electrode 14 for the segment being changed from level L5 (black) to level L1 (white), and SEG2 is the drive signal (drive voltage) applied to the segment electrode 14 for the segment being changed from level L1 (white) to level L5 (black). Unless necessary to specifically differentiate drive signals SEG1 and SEG2, the drive signal is referred to as drive signal SEG below.

As shown in FIG. 9, redraw period Ta is the period from time M1A to time M1B where time M1A is the time when the control circuit 57 starts outputting the redraw display signal (drive data) to the display drive circuit 40, and time M1B is the time when redrawing the display is completed. Rest period Tb is time other than redraw period Ta. The redraw period Ta is the period in which the display drive circuit 40 supplies the drive signals (drive voltages) COM, SEG to the common electrode 25 and segment electrodes 14 to change the display color of each segment 5X and change the displayed time.

The rest period Tb is the time between after the displayed time, for example, has been changed until the display drive circuit 40 inputs the next display switching signal, and the display drive circuit 40 enters an energy conservation mode during rest period Tb. In addition, the output terminal of the display drive circuit 40 for outputting the drive signals COM, SEG is set to a high impedance state (HI-Z in FIG. 9) during rest period Tb.

A potential difference between the common electrode 25 and segment electrodes 14 therefore does not occur during the rest period Tb, and the display color of each segment therefore remains the same color that was set in the redraw period Ta.

This embodiment of the invention also changes the display color from level L1 (white) to level L5 (black) parallel to changing the display color from level L5 (black) to level L1 (white) during the redraw period Ta. More specifically, the display drive circuit 40 outputs a drive signal SEG to apply a drive voltage of a level corresponding to the display color (white or black in this aspect of the invention) to be presented in each segment to the segment electrode 14 of each segment, and outputs a drive signal COM in which the voltage varies over time to the voltage corresponding to the display color to the common electrode 25.

The drive signal COM is a pulse signal of which the voltage changes between a HIGH level (+12 V) and a LOW level (0 V) according to the display switching signal (drive data). The pulse width W of one pulse of the drive signal COM is set to a frequency (such as 62.5 ms= 1/16 second) that can be generated by frequency dividing a signal output from the oscillation circuit 51A, and a pulse signal output as drive signal COM can be generated based on this frequency division signal.

The number of pulses applying a voltage to segments 5X can thus be effectively adjusted to adjust the gray level of the display color presented in each segment 5X.

As a result, when the drive signal COM voltage during redraw period Ta is LOW, a potential difference is produced for pulse width W between the common electrode 25 and the segment electrode 14 of the segment to which a HIGH drive signal SEG is supplied, the black particles 34 in the microcapsules 31 therefore migrate to the common electrode 25 side, and the white particles 35 migrate to the segment electrode 14 side.

The display color of the segment also shifts an amount determined by the pulse width W towards level L5 (black).

When the drive signal COM voltage then goes to HIGH, a potential difference is produced for pulse width W between the common electrode 25 and the segment electrode 14 of the segment to which the LOW drive signal SEG is applied, the white particles 35 inside the microcapsules 31 therefore migrate toward the common electrode 25 and the black particles 34 migrate toward the segment electrode 14.

As a result, the display color of the segment also shifts an amount determined by the pulse width W towards level L1 (white).

As this operation continues, the black particles 34 and white particles 35 gradually move between the common electrode 25 and segment electrodes 14 according to the change in the drive signal COM voltage over time. As a result, the display color of each segment changes in steps, and at the conclusion of the redraw period Ta the corresponding segments have changed to the same display color.

In the example shown in FIG. 9, the color presented by the segment 5X corresponding to drive signal SEG2 starts changing from time M1A when display switching signal (drive data) output starts.

The display color of the segment 5X corresponding to drive signal SEG1 does not start changing until 8/16 second after the time M1A when display switching signal (drive data) output starts, however, because the drive signal SEG1 is synchronized to the drive signal COM.

When the drive signal SEG1 goes LOW 8/16 second after time M1A when display switching signal (drive data) output starts, the display color of the segment 5X corresponding to drive signal SEG1 starts to change, and the change is completed at time M1B simultaneously to the segment 5X corresponding to drive signal SEG2.

By shifting the timing at which applying drive pulses starts when the number of drive pulses required to change different display areas to the same display color differs, this aspect of the invention completes changing the display color at the same time and thus avoids creating visually dissonant display colors.

The invention is not limited to the embodiment described above, and can be varied in many ways without departing from the scope of the accompanying claims.

For example, the effective number of pulses is changed according to the display color before the display is changed and the display color after the display color is changed while also adjusting the timing of the first drive pulse. Additionally, however, the effective pulse count and the timing of the first drive pulse can also be adjusted according to the size of the display area being changed (because changing the display color becomes more difficult as the area increases) or how long the same display color was presented before the display color is changed (because changing the display color becomes more difficult as the time a particular color is displayed increases).

Further alternatively, instead of or in addition to changing the pulse count, the voltage of the drive signal SEG can be changed according to the initial display color and the display color after the display is redrawn.

Yet further alternatively, instead of or in addition to changing the pulse count, the pulse width of the effective pulses can be changed according to the initial display color and the display color after the display is redrawn.

The aspect of the invention described above changes the timing of the first drive pulse, but the drive signal could be downsampled according to the required effective pulse count ratio. For example, if the pulse count ratio is 2:3, the waveform of the drive signal SEG can be the same as the waveform of the drive signal COM so that the drive signal SEG applied to the segment corresponding to the 2 in the pulse count ratio does not apply a voltage once every three pulses.

The pulse counts required to effect a display change are compiled in a table for the initial display level and the display level after the display color changes, but the timing of the first drive pulse can be compiled in a table instead of the pulse count.

Furthermore, a segment type electrophoretic display panel 5 is used for example above, but the invention is not limited to a segment display, and a dot matrix display could be used instead. What is essential to the invention is that the method described above is used to change the drive pulse count or other parameter based on the gray level of the display color presented in each display unit (segment or dot), the continuous display time, and the size of the area being redrawn to a different display color.

The voltage applied by the drive signals SEG1 and SEG2 is the same in the embodiment described above, but the voltage of the drive signals SEG1 and SEG2 can differ so that the electrophoretic particles move the same distance when the same number of drive pulses is applied.

In this case the voltage of drive signal SEG1 and drive signal SEG2 can also be changed independently of the other according to the initial display level and the display level after the display is redrawn by, for example, providing fixed reference voltage sources equal in number to the number of voltage levels used, or two variable reference voltage sources.

This embodiment of the invention is described using a wristwatch by way of example, but the invention is not so limited and can be applied to a wide range of electronic devices (display devices) having an electrophoretic display panel and a drive device for driving the display panel, including, for example, mantle clocks, wall clocks, grandfather clocks, pocket watches, and other types of timepieces. The invention can also be used with any electronic device having a display function for which an electrophoretic display panel can be used, including personal digital assistants (PDA) and cell phones.

The entire disclosure of Japanese Patent Application No. 52-70791, filed Oct. 20, 1975 is expressly incorporated by reference herein.

What is claimed is:

1. A display control apparatus for controlling an electrophoretic display panel having two types of electrophoretic particles of different color and polarity between electrodes, the display control apparatus comprising:
a drive unit for supplying a pulse wave drive signal to apply a drive voltage between the electrodes to change a display color of the electrophoretic display panel to a color between the colors of the electrophoretic particles and display a gray level color; and
a migration state control unit for controlling migration of the electrophoretic particles by means of the drive unit based on the target display color, which is the display color to be displayed, and the difference in the migration characteristics of the two types of electrophoretic particles.

2. The display control apparatus described in claim 1, wherein:
the migration state control unit comprises a migration timing control unit for controlling a migration start time by means of the drive unit so that the migration end time is the same in all areas when changing a plurality of areas of different display colors to the same color.

3. The display control apparatus described in claim 1, wherein:
the migration state control unit comprises a pulse application control unit for controlling a pulse application time by means of the drive unit so that the migration end time is the same in all areas when changing a plurality of areas of different display colors to the same color.

4. The display control apparatus described in claim 1, wherein:
the migration state control unit comprises a voltage control unit for changing the voltage of the drive signal applied to each area so that the migration end time is the same in all areas when changing a plurality of areas of different display colors to the same color.

5. The display control apparatus described in claim 1, wherein:
the migration state control unit comprises a pulse width control unit for controlling the drive signal pulse width by means of the drive unit so that the migration end time is the same in all areas when changing a plurality of areas of different display colors to the same color.

6. The display control apparatus described in claim 1, further comprising:
a pulse data storage table for storing a pulse count of a pulse wave drive signal or the voltage application time effected by a pulse wave drive signal required to change from a current display color to a target display color;
wherein the migration state control unit references the pulse data storage table to control the migration state of the electrophoretic particles when changing the display color of display areas of a plurality of different display colors to the same color.

7. A display device comprising:
an electrophoretic display panel having two types of electrophoretic particles of different color and polarity between electrodes;
a drive unit for supplying a pulse wave drive signal to apply a drive voltage between the electrodes to change a display color of the electrophoretic display panel to a color between the colors of the electrophoretic particles and display a gray level color; and
a migration state control unit for controlling migration of the electrophoretic particles by means of the drive unit based on the target display color, which is the display color to be displayed, and the difference in the migration characteristics of the two types of electrophoretic particles.

8. The display device described in claim 7, wherein:
the migration state control unit comprises a migration timing control unit for controlling a migration start time by means of the drive unit so that the migration end time is the same in all areas when changing a plurality of areas of different display colors to the same color.

9. The display device described in claim 7, wherein:
the migration state control unit comprises a pulse application control unit for controlling a pulse application time by means of the drive unit so that the migration end time is the same in all areas when changing a plurality of areas of different display colors to the same color.

10. The display device described in claim 7, wherein:
the migration state control unit comprises a voltage control unit for changing the voltage of the drive signal applied to each area so that the migration end time is the same in all areas when changing a plurality of areas of different display colors to the same color.

11. The display device described in claim 7, wherein:
the migration state control unit comprises a pulse width control unit for controlling the drive signal pulse width by means of the drive unit so that the migration end time is the same in all areas when changing a plurality of areas of different display colors to the same color.

12. The display device described in claim 7, further comprising:
a pulse data storage table for storing a pulse count of a pulse wave drive signal or the voltage application time effected by a pulse wave drive signal required to change from a current display color to a target display color;
wherein the migration state control unit references the pulse data storage table to control the migration state of the electrophoretic particles when changing the display color of display areas of a plurality of different display colors to the same color.

13. A display control method for a display device having an electrophoretic display panel having two types of electrophoretic particles of different color and polarity between electrodes and a display unit for driving the electrophoretic display panel, the display control method comprising steps of:
supplying a pulse wave drive signal to apply a drive voltage between the electrodes to change a display color of the electrophoretic display panel to a color between the colors of the electrophoretic particles and display a gray level color; and
controlling migration of the electrophoretic particles by means of the drive unit based on the target display color, which is the display color to be displayed, and the difference in the migration characteristics of the two types of electrophoretic particles.
